(19) United States
(12) Patent Application Publication
(10) Pub. No.: US 2013/0320164 A1
(43) Pub. Date: Dec. 5, 2013

(54) DOUBLE ACTING SUCTION CUP

(71) Applicants: HUISOK PYON, Paramount, CA (US); Andrea Beatriz Montes, Los Angeles, CA (US); Steven Bryan Dunn, Beverly Hills, CA (US)

(72) Inventors: HUISOK PYON, Paramount, CA (US); Andrea Beatriz Montes, Los Angeles, CA (US); Steven Bryan Dunn, Beverly Hills, CA (US)

(73) Assignee: MUNCHKIN, INC., North Hills, CA (US)

(21) Appl. No.: 13/905,095

(22) Filed: May 29, 2013

Related U.S. Application Data
(60) Provisional application No. 61/652,415, filed on May 29, 2012.

(51) Int. Cl. F16B 47/00

(52) U.S. Cl. CPC F16B 47/00
USPC 248/206.3

(57) ABSTRACT

A double suction cup having a first suction cup with a first internal face and a second suction cup having a second internal face. The first suction cup is attached to the second suction cup via an interconnecting base member. At least one protrusion is disposed on at least one of the internal faces of the suction cups to prevent the first or second suction cup from completely flattening and to maintain a tight vacuum on the object the first and second suction cup is attached to.

### CROSS REFERENCE TO RELATED APPLICATION

This application claims priority to U.S. Provisional Patent Application Ser. No. 61/652,415, filed May 29, 2012; the contents of which are hereby incorporated by reference herein in their entirety into this disclosure.

### TECHNICAL FIELD

The subject disclosure relates generally to suction cups, and more specifically to a double acting suction cup.

### BACKGROUND

Flexible vacuum cups and suction cups are well known and in use for attaching the suction cup to an object. Not to be confused with vacuum cups, suction cups rely on a sophisticated vacuum pump for maintaining a constant vacuum between the inner surface of the cup and the surface to which the cup is to be attached. The advantage of the suction cup over the vacuum cup is the simplicity and ease with which the suction cup may be maneuvered, applied and released to another object. Various other advantages include eliminating the need for the cumbersome vacuum components, thereby reducing cost of manufacture and operation.

Despite the ineffectiveness of a conventional vacuum and suction cups, a need exists for a simple and efficient double acting suction cup capable of securing a first suction cup to a first object and a second suction cup to a second object.

### BRIEF DESCRIPTION OF THE DRAWINGS

Various exemplary embodiments of this disclosure will be described in detail, wherein like reference numerals refer to identical or similar components or steps, with reference to the following figures, wherein:

FIGS. 1-2 illustrate exemplary perspective views of a double suction cup according to the subject disclosure.

FIG. 3 depicts a cross-section view of the double suction cup.

FIG. 4 shows a side view of the double suction cup.

FIG. 5 illustrates a view of the larger suction cup of the double suction cup.

FIG. 6 shows a view of the smaller suction cup of the double suction cup.

FIGS. 7-8 depict various views of the intimate suction contact created by the first suction cup of the double suction cup.

FIGS. 9-10 illustrate various views of the intimate suction contact created by the second suction cup of the double suction cup.

FIG. 11 shows an exploded view of a double suction cup assembly.

FIG. 12 shows a perspective view of the double suction cup assembly shown in FIG. 11.

FIG. 13 shows an alternative perspective view of a double suction cup assembly.

FIG. 14 shows an exploded view of a double suction cup assembly and connection therefore.

FIG. 15 shows an exploded view of the double suction cup assembly.

FIG. 16 shows a cross section view of the double suction cup assembly in a first position.

FIG. 17 shows a cross section view of the double suction cup assembly in a second position.

FIG. 18 shows a side view of another embodiment for a double suction cup assembly having an actuation handle.

FIG. 19 shows a cross section view of the double suction cup assembly in the first position.

FIG. 20 shows a cross section view of the double suction cup assembly in the second position.

FIG. 21 shows a perspective view of the handle of the double suction cup assembly in the first position.

FIG. 22 shows a perspective view of the handle of the double suction cup assembly in the second position.

FIG. 23 shows a perspective view of the first and second suction cups and associated retainers of the double suction cup.

FIG. 24 shows an exemplary cut-away section of the double suction cup illustrating the retainers in position.

FIG. 25 shows an exemplary cut-away section of the double suction cup illustrating the drive collar in position.

### DETAILED DESCRIPTION

Particular embodiments of the present invention will now be described in greater detail with reference to the figures.

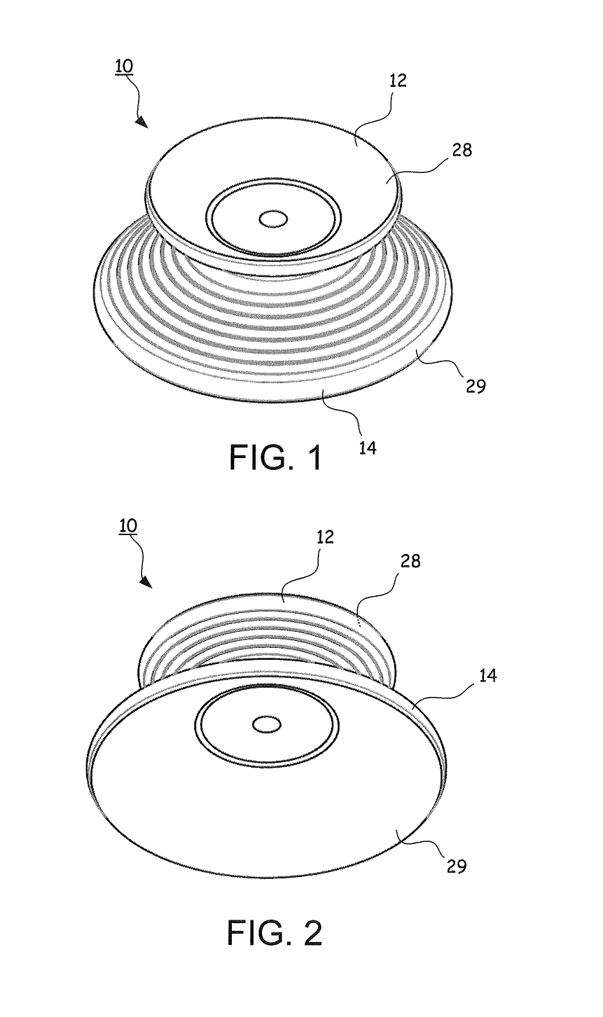

FIGS. 1-2 illustrate perspective views of an exemplary double suction cup 10 from a top perspective view and a lower perspective view. As shown, the double suction cup 10 includes a first suction cup 12 integrally connected to a second suction cup 14. The first suction cup 12 and the second suction cup 14 are configured as two opposing arcuate shaped aprons flaring open having walls 28, 29 extending outward from each other.

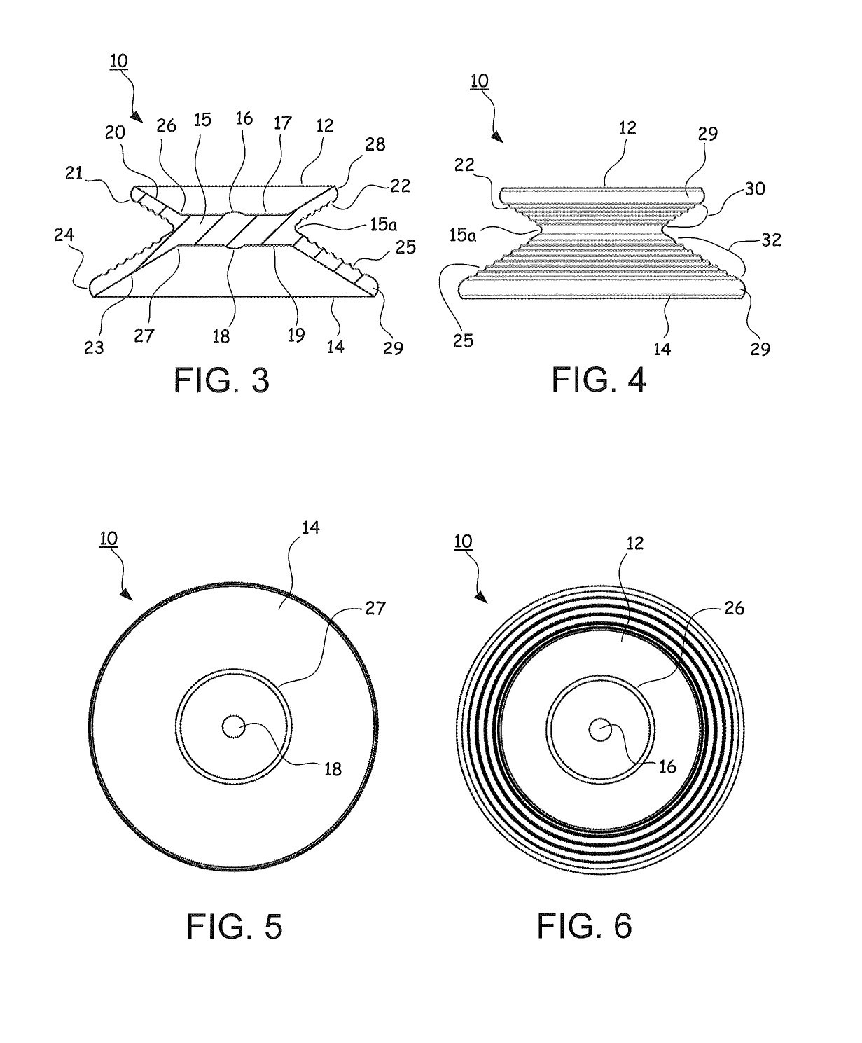

Referring to FIGS. 3-6, the first suction cup 12 is connected to the second suction cup 14 via an interconnected base 15 member. The interconnected base 15 is a circular and cylindrical shape and, as shown in the drawings, is coaxial with the first suction cup 12 and the second suction cup 14.

According to this embodiment, the interconnected base 15 is solid and includes a first base face 17 on a first side defining the first suction cup 12. The first base face 17 is comprised of an enlarged circular section disposed in the center of the first suction cup 12 and encircled by a first concentric leading edge 26. The first concentric leading edge 26 is defined by the adjoining edges of the first base face 17 and an inner concave surface 20 of the first suction cup 12.

Likewise, on an opposite side, the interconnected base 15 includes a second base face 19 on a second side defining the second suction cup 14. The second base face 19 is comprised of an enlarged circular section disposed in the center of the second suction cup 14 and encircled by a second concentric leading edge 27. The second concentric leading edge 27 is defined by the adjoining edges of the second base face and an inner concave surface 23 of the second suction cup 14.

A slight protrusion 16 is provided on the first base face 17 of the interconnected base 15 of the first suction cup 12 at approximately the axial center of the first base face 17. Another slight protrusion 18 is provided on the second base face 19 of the interconnected base 15 of the second suction cup 14 at approximately the axial center of the second base face 19.

The first suction cup 12 and the second suction cup 14 may be made of natural or synthetic rubber, or rubber-like material including certain plastic and resilient and flexible materials.

The inner concave surface 20 of the first suction cup 12 begins at the first concentric leading edge 26 and terminates at a peripheral lip 21. The first suction cup 12 also has an outer convex surface 22 beginning at an outer central concentric surface 15a of the interconnecting base 15 and terminating at the peripheral lip 21.

The inner concave surface 23 of the second suction cup 14 begins at the second concentric leading edge 27 and terminates at a peripheral lip 24. The second suction cup 14 also has an outer convex surface 25 beginning at an outer central concentric surface 15a of the interconnecting base 15 and terminating at the peripheral lip 24.

In FIG. 4, the outer convex surface 22 of the first suction cup 12 includes a plurality of successive annular rings or continuous grooves 30 that gradually increase in diameter outward from the outer central concentric surface 15a of the interconnecting base 15 to the peripheral lip 21. Likewise, the outer convex surface 25 of the second suction cup 14 also includes a plurality of successive annular rings or continuous grooves 32 that gradually increase in diameter outward from the outer central concentric surface 15a of the interconnecting base 15 to the peripheral lip 24.

The various grooves 30, 32 resemble an undulating groove surface shape over the outer convex surfaces 22, 25 of the first suction cup 12 and the second suction cup 14 respectively. The purpose of providing the various continuous grooves 30, 32 is to reduce the thickness of, and weaken the walls 28, 29 of the first and second suction cups 12, 14 so that the walls 28, 29 can easily deform to the surface it is being suctioned on to. The various grooves 30, 32 disposed in the walls 28, 29 of the suction cups 12, 14 modify the flexible properties of the walls 28, 29 of the suction cups 12, 14 in a discernible manner compared to a suction cup without the grooves where flexibility is dramatically reduced.

In the region defined by the grooves 30, 32, annular zones are created which are substantially flexible. Within those annular zones, there is less resistance in the flexibility of the walls 28, 29 of the first suction cup 12 and the second suction cup 14 when the cups are attached to a suction surface. That is, when one of the first suction cup 12 or the second suction cup 14 is pressed against a surface, the walls 28, 29 will flex or yield primarily in the region defined by the annular zones, and because the body is reduced in thickness within these zones, the suction cup can be flattened more easily against the surface until the slight protrusions 16, 18 rest against the associated suction surface.

A volume defined by a concentric vacuum space defined by the surfaces of the protrusions 16, 18, the faces 17, 19, and the walls 28, 29 act to secure the suction cups 12, 14 to the surface of the items being suctioned. According to this construction, the application of less pressure is required to create the vacuum in the suction cups 12, 14 since less thickness in the annular zones of the walls 28, 29 of the suction cups 12, 14 is required to overcome when the suction cups 12, 14 flex against the suctioned surface. The force required to exert on the suction cups 12, 14 against a surface being suctioned is substantially reduced in order for a vacuum suction to be made.

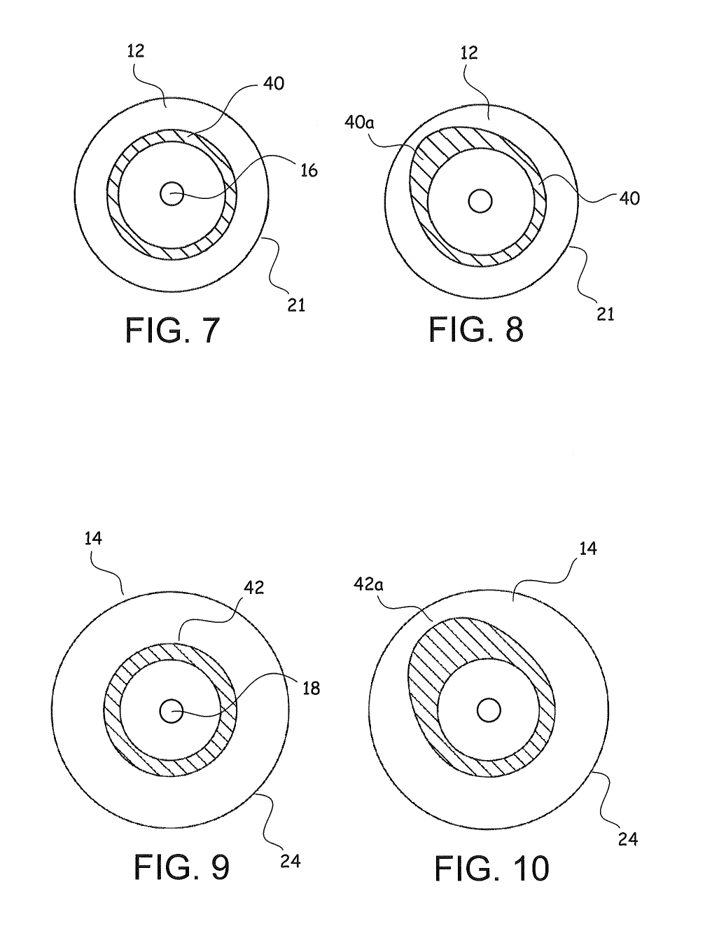

FIGS. 7-10 illustrate various views of the intimate suction contact created by the first and second suction cups 12, 14 of the double suction cup 10. As shown, intimate suction contact is created by the double suction cups 12, 14 with a pair of surfaces. In FIG. 7, a first suction contact surface 40 is created substantially central to the concentric surface area of the first suction cup 12 between the protrusion 16 and the peripheral edge 21. Similarly, as shown in FIG. 9, a second suction contact surface 42 is provided substantially central to the concentric surface area of the second suction cup 14, between the protrusion 18 and the peripheral edge 24.

Unlike the present disclosure, a conventional suction cup without the annular grooves would generate a first and second suction contact surface that would be much closer to the outer peripheral edges 21, 24 of the suction cups respectively. Unfortunately, the amount of force required to attach the suction cups 12, 14 to a surface would be substantially greater and the amount of force required to remove the suction cups 12, 14 from the attached surfaces would be substantially lower. Likewise, conventionally, slight movement of the suction cups 12, 14 would have a greater tendency to cause the suction cups 12, 14 to lose its vacuum suction and disengage from its attached surface.

According to the subject disclosure, and as shown in FIGS. 8 and 10, as the first and second suction cups 12, 14 are pulled from suction surfaces respectively, the intimate suction contact surfaces 40, 42 (shown in FIGS. 7 and 9) are allowed to stretch and/or expand as shown by the expansion contact surfaces 40a, 42a. Advantageously, the expansion contact surfaces 40a, 42a increase the suction capability of the suction contact surface outward over a greater radial range toward the peripheral edges 21, 24 of the first and second suction cups 12, 14 from a central position on the faces 17, 19 of the suction cups 12, 14.

By initially creating the suction contact surfaces 40, 42 closer to the center of the suction cups, the suction contact surfaces 40, 42 are able to flexibly stretch 40a, 42a further outward toward the peripheral edges 21, 24 of the first and second suction cups 12, 14 before the vacuum suction is lost and either of the suction cups 12, 14 is disengaged from the vacuum surface. This stretching allows the vacuum suction to be present and stretched over a greater surface area of the object that is attached to the suction cup.

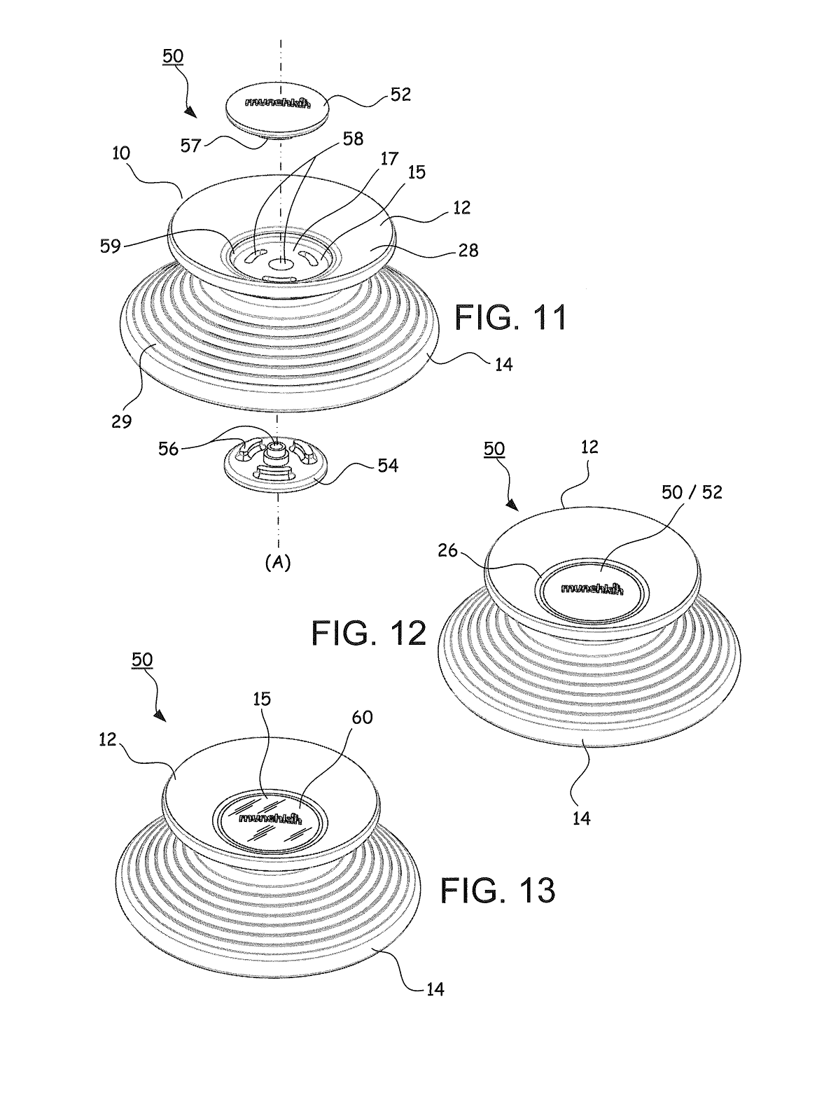

FIGS. 11-12 illustrate another exemplary embodiment in which a rigid fastener 50 including a plate 52 and retainer 54 are secured through the interconnecting member 15 of the double suction cup 10.

The plate 52 of the fastener 50 may be provided on a first face 17 of the interconnecting member 15, and the second retainer 54 may be provided on a second face 19 of the interconnecting member 15. The plate 52 and retainer 54 may be connected to each other via various mating posts 56 and receptacles 57 that fasten to each other across the interconnecting member 15. Various apertures 58 may be provided in the interconnecting member 15 through which the various mating posts 56 and receptacles 57 are disposed and joined together.

As shown in FIGS. 11-12, the fastener 50 may be provided in a recess 59 disposed in the first base face 17 and the second base face 19 of the interconnecting member 15 so that the top of plate 52 and the top of the retainer 54 sit substantially flush or level with the first concentric leading edge 26 and the second concentric leading edge 27.

The fastener 50 is adapted to provide rigidity to the interconnecting member 15 of the double suction cup 10. In use, the rigidity of the fastener 50 will ensure that the walls 28, 29 of the double suction cup 10 symmetrically attach to an object by preventing the respective first base 17 and the second base 19 of the interconnecting member 15 from shifting from a center and/or over-flexing so as to disrupt the seal made between the wall 28, 29 of the suction cups 12, 14 and the object being attached.

The connection may be a mechanical connection, such as a snap connection. Alternatively, the connection may be made by welding, fusing, using an adhesive and/or any other suitable means for connecting the plate 52 to the retainer 54.

FIG. 13 illustrates another exemplary method for providing a rigid disk 60 disposed directly into the interconnecting member 15. Although the rigid fastener 50 is shown in FIGS. 11-12 connected on both sides of the interconnecting member 15, it is to be understood that the rigidity desired at the interconnecting member 15 may be provided by placing a solid disk 60 inside of the interconnecting member 15. The disk 60 can be molded during construction into the center of the interconnecting member 15 and/or provided in any other suitable manner within the interconnecting member 15 in accordance with this subject disclosure.

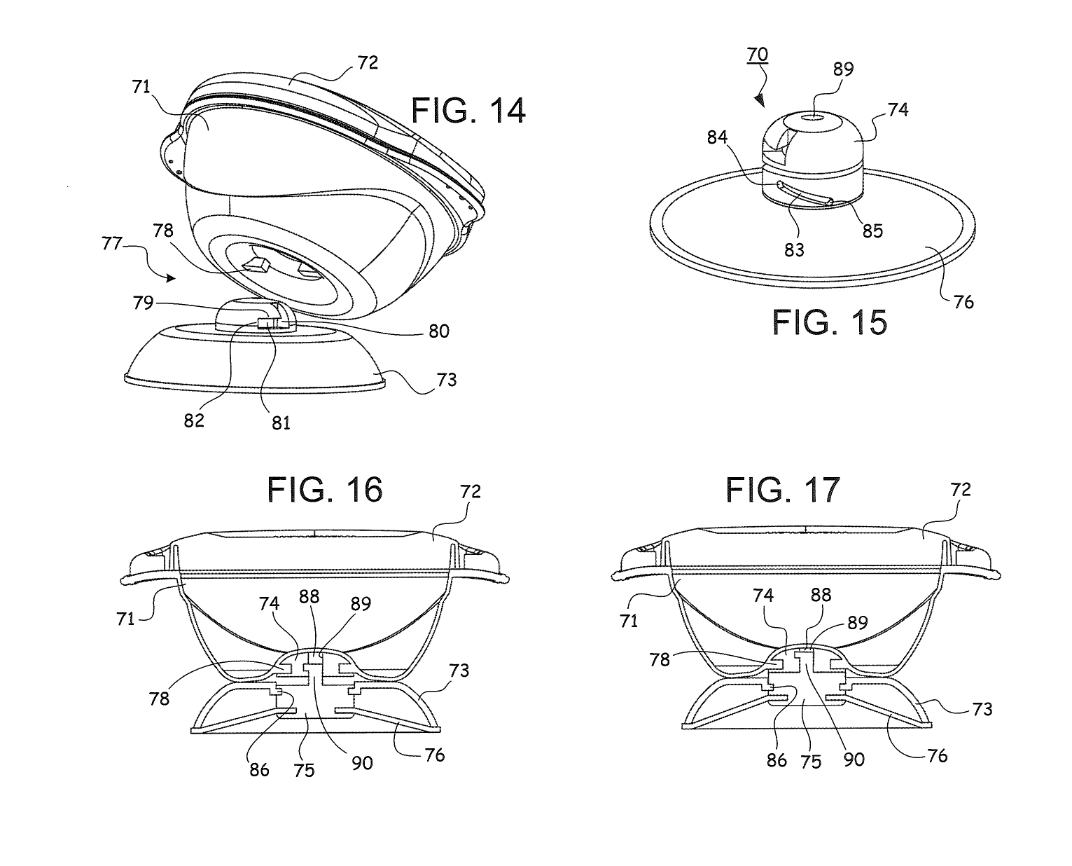

FIGS. 14-17 illustrate another exemplary suction cup plunger assembly. A suction cup plunger assembly 70 is provided that is adapted to connect a container 71 with a lid 72 to a base 73. As shown in FIGS. 15-17, the suction cup plunger assembly 70 includes a drive stack 74 connected to a retainer 75 that is attached to a suction cup 76.

FIG. 14 shows the container 71 including a connection mechanism 77. The connection mechanism 77 may include a pair of mating connection elements. As shown attached to the bottom of the container 71 is pair of locking tabs 78 adapted to be received in a locking keyway of slot 79.

The slot 79 is provided with a vertical alignment slot 80 and a circumferential slot 81 that extends radially outward from a lower end of the vertical alignment slot 80 to a predetermined distance that terminates at a back wall 82 of a circumferential slot 81. The back wall 82 acts as a stop for the rotating locking tabs 78.

As shown in FIG. 16, the drive stack 74 includes a keyed internal female slot 89 adapted to receive a mating male key projection 90 of the retainer 75. The keyed internal female slot 89 and male key projection 90 connection are adapted to align the drive stack 74 to the retainer 75.

FIG. 15 further illustrates a circumferential inclined drive slot 83. The inclined drive slot 83 includes a first terminating end 84 and a second terminating end 85. The first terminating end 84 is provided at a circumferential elevation that is higher than a circumferential elevation of the second terminating end 85. As shown in FIGS. 16-17, the base 73 includes an alignment projection 86 adapted to travel within the inclined drive slot 83.

FIG. 16 illustrates a first position in which the alignment projection 86 is positioned at the first terminating end 84. When the alignment projection 86 is positioned at the first terminating end 84, the projection 86 is resting at the highest elevation in the inclined drive slot 83 adjacent to the first terminating end 84. In this position, the suction cup 76 is in a rest position as shown in FIG. 16.

FIG. 17 illustrates a second position in which the alignment projection 86 is positioned at the second terminating end 85. When the alignment projection 86 is positioned at the second terminating end 85, the projection 86 rests at the lowest elevation in the inclined drive slot 83 nearest the second terminating end 85. In this position, the retainer 75 at the center of the suction cup 76 has been driven upward away from a surface below the suction cup 76 as a result of the circumferential twisting movement of the projection 86 within the inclined drive slot 83 and has come to rest at the second terminating end 85 as shown in FIG. 17. The upward movement of the suction cup 76 increases the negative vacuum pressure within the suction cup 76 providing a secure hold on the surface that the suction cup 76 is attached to.

In use, the container 71 and locking tabs 78 disposed at the bottom of the container 71 are aligned within the slot 80 and pressed downward until the locking tabs 78 rest against the bottom of the circumferential slot 81. The container 71 is then rotated clockwise until the locking tabs 78 slide to the back end of the circumferential slot 81 and rest against a back wall 82 thereof.

As the container 71 is further rotated, the drive stack 74 fixed in a recess 88 of the container 71 rotates with the rotation of the container 71 until the projections 78 disposed in a bottom of the container 71 rotate and abut up against the back wall 82 of the radial slot 82. As the container 71 continues to be rotated, the projection 86 disposed at rest within the inclined drive slot 83 at position shown in FIG. 16 travels from the first terminating end 84 of the inclined drive slop 83 toward the second terminating end 85.

As mentioned above in FIGS. 16-17, as the projection 86 moves within the inclined drive slot 83 from the position associated with the first terminating end 84 toward a position associated with the second terminating end 85, the male key projection 90 of the retainer 75 is driven upward away from the bottom of the base 73 into the keyed female receptacle 89 disposed in the drive stack 74. This upward movement of the retainer 75 pulls the suction cup 76 upward thereby increasing the negative vacuum pressure within the suction cup 76 and providing a secure vacuum hold on the surface of an item that the suction cup 76 is attached to.

Unlike conventional systems that require additional levers and the like, the advantage of this suction cup assembly 70 system is that no additional levers or mechanism are required to move the suction cup 76 upward within the base 73. Likewise, the negative vacuum pressure created within the suction cup 76 is automatic in response to placement of the container 71 and rotation of the container 71 over the base 73.

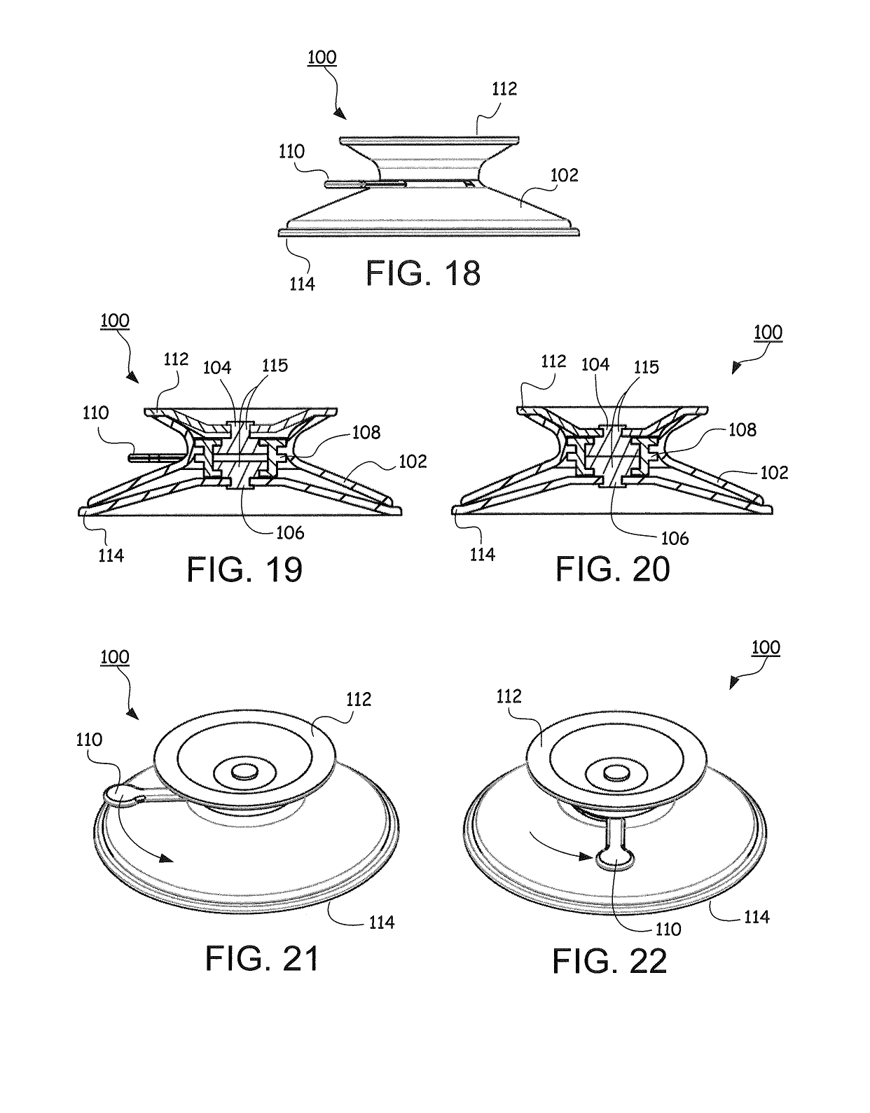

FIGS. 18-22 illustrate another exemplary double suction cup plunger assembly 100. The double suction cup plunger assembly 100 illustrated includes an outer body 102 in the shape of a hallow hour-glass shape having a first open end and a second open end. The outer body 102 has a first suction cup 112 disposed adjacent to the first open end and a second suction cup 114 disposed adjacent to a second open end.

The first suction cup 112 is attached to a second suction cup 114 through a separable interconnecting member 115. The separable interconnecting member 115 includes a first member or retainer 104 attached to a first suction cup 112, and a second member or retainer 106 attached to a second suction cup 114. The first retainer 104 and the second retainer 106 are disposed within a drive collar 108 attached to a handle 110. The first retainer 104 and the second retainer 106 slide independently of each other from an open position (as shown in FIGS. 19 and 21) to a retracted position (as shown in FIGS. 20 and 22).

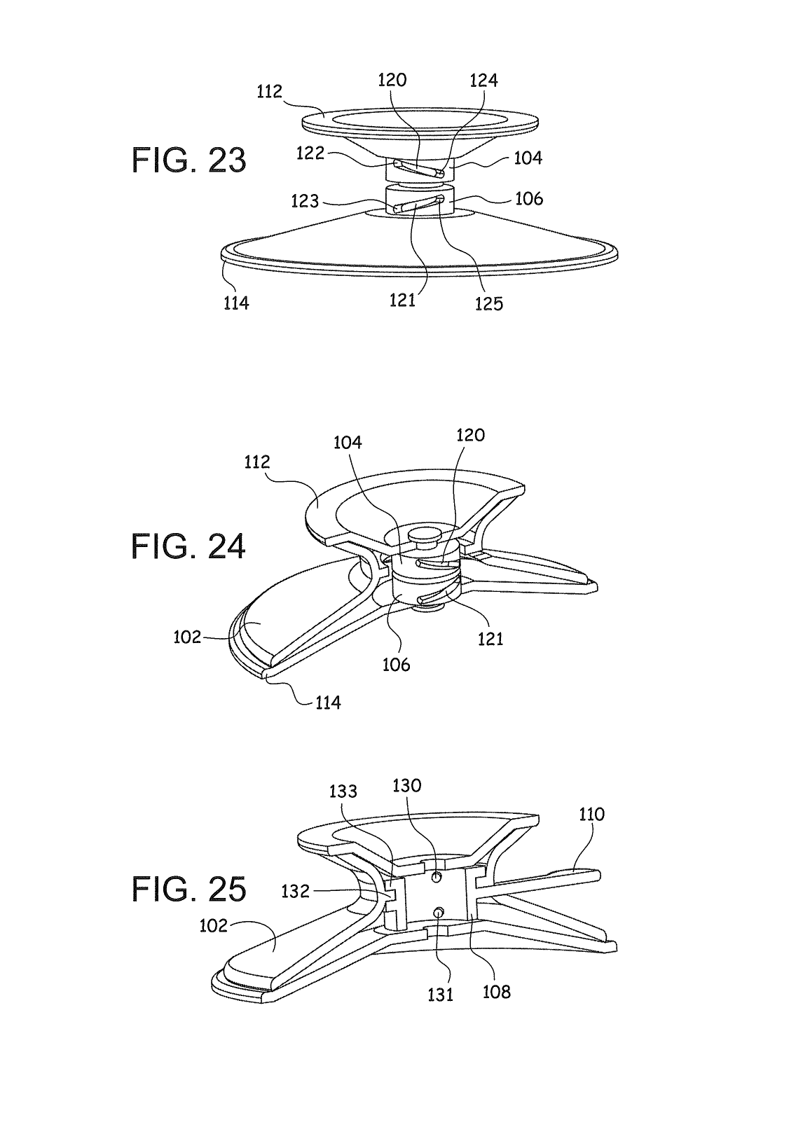

As shown in FIGS. 23-24, the first retainer 104 and the second retainer 106 include respective inclined drive slopes 120, 121. Each of the inclined drive slopes 120, 121 include respective first terminating ends 122, 123 and second terminating ends 124, 125, respectively.

FIG. 25 further demonstrates the drive collar 108 disposed within the outer body 102. The outer body 102 includes a flange 132 around which a mating concentric recess 133 in the drive collar 108 is provided. The drive collar 108 concentrically rotates along the flange 132 as the handle 110 is moved from the open position (as shown in FIGS. 19 and 21) to the retracted position (as shown in FIGS. 20 and 22).

The drive collar 108 includes a pair of alignment projections 130, 131 that mate with, and are adapted to travel within the recesses defined in the inclined drive slopes 120, 121.

When the pair of alignment projections 130, 131 are disposed at the position of the first terminating ends 122, 123, the alignment projections 130, 131 are provided at a circumferential elevation that is closer to the first and second suction cups 112, 114 respectively. In this first position as shown in FIGS. 19 and 21, the first and second retainers 104, 106 are positioned farthest outward toward the first and second suction cups 112, 114 respectively. At this point and the suction cups 112, 114 are at rest.

When the alignment projections 130, 131 are disposed at the position of the second terminating ends 124, 125, the alignment projections 130, 131 are provided at a circumferential elevation that is farthest away from the first and second suction cups 112, 114 respectively. In this second position, as shown in FIGS. 20 and 22, the first and second retainers 104, 106 are positioned closest inward away from the first and second suction cups 112, 114 respectively. As such, further suction is positively provided by the retracted position of the first and second suction cups 112, 114 by the inward pull of the retainers 104, 106 against the first and second suction cups 112, 114. The inward movement of the suction cups 112, 114 increases the negative vacuum pressure within the suction cups 112, 114 providing a secure hold on the surface that they are attached to respectively.

In use, as the handle 110 and the drive collar 108 are rotated from a first position (shown in FIGS. 19 and 21) to a second position (shown in FIGS. 20 and 22), the alignment projections 130, 131 move from the first terminating ends 122, 123 within the inclined drive slots 120, 121 toward the second terminating end 124, 125 within the inclined drive slots 120, 121. This movement causes the first and second suction cups 112, 114 to retract inward thereby increasing the negative vacuum pressure within the suction cups 112, 114. This movement provides a secure vacuum hold on the surfaces of the various items that the suction cups 112, 114 are attached to.

The double suction cup plunger assembly 100 according to this subject disclosure can be used to secure various objects, such as dinnerware to a surface, a memo pads to any flat surface whether it be vertical, horizontal or diagonal, and/or any other suitable object. Depending on the size and/or weight of the object, a number of holders may be utilized such as one in each corner of the object.

Various materials may be used according to this disclosure including, but not limited to: polypropylene, a thermoplastic elastomer, a high density polyethylene, polycarbonate, urethane rubber, silicone and/or any other suitable material may be used.

The illustrations and examples provided herein are for explanatory purposes and are not intended to limit the scope of the appended claims. It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

What is claimed:

1. A double suction cup comprising:
a first suction cup having a first internal face;
a second suction cup having a second internal face, attached to the first suction cup via an interconnecting member; and
at least one protrusion disposed on at least one internal face to prevent the first or second suction cup from completely flattening and to maintain a vacuum space.

2. The double suction cup recited in claim 1, wherein the first and second suction cups define two opposing arcuate shaped aprons flaring open having walls extending outward from each other.

3. The double suction cup recited in claim 1, wherein the interconnected member is solid and includes a first base face on the first internal face and a second base face on the second internal face.

4. The double suction cup recited in claim 1, wherein the protrusion is provided at approximately the axial center of the at least one of the first or second internal face base of the interconnected member.

5. The double suction cup recited in claim 1, wherein the outer convex surface of the first suction cup includes a plurality of successive annular rings that gradually increase in diameter outward from the outer central concentric surface of the interconnecting base to the peripheral lip.

6. The double suction cup recited in claim 1, further comprising a rigid fastener including a plate and a retainer secured through the interconnecting member.

7. The double suction cup recited in claim 6, wherein the plate and the retainer are connected to each other by at least one mating posts and receptacles that fasten to each other across the interconnecting member.

8. The double suction cup recited in claim 6, wherein a top of the plate and a top of the retainer sit substantially flush with a first and a second concentric leading edge of the interconnecting member.

9. The double suction cup recited in claim 1, wherein the double suction cup is provided to connect a first object to a second object.

10. The double suction cup recited in claim 1, wherein an outer diameter of the first suction cup is smaller than a second diameter of the second suction.

11. A double suction cup comprising:
a first suction cup having a first internal face and an outer convex surface having a plurality of successive annular rings;
a second suction cup having a second internal face and an outer convex surface having a plurality of successive annular rings, the second suction cup attached to the first suction cup via an interconnecting member; and
at least one protrusion disposed on the first or second internal face that prevents the first or second suction cup from completely flattening.

12. The double suction cup recited in claim 11, wherein the plurality of successive annular rings gradually increase in diameter outward from an outer central concentric surface of the interconnecting to a peripheral lip on at least one of the first and second outer convex surfaces.

13. The double suction cup recited in claim 11, further comprising a rigid fastener including a plate and a retainer secured through the interconnecting member.

14. The double suction cup recited in claim 11, wherein the protrusion is provided at approximately the axial center of the at least one of the first or second internal face base of the interconnected base.

15. The double suction cup recited in claim 11, further comprising a rigid fastener including a plate and a retainer secured through the interconnecting member.

16. A double suction cup comprising:
a first suction cup having a first convex apron shape;
a second suction cup having a second convex apron shape;
a hallow body having a first end and a second end, and a track disposed in a mid-portion of the body into which a handle travels;
a collar attached to the handle; and
a separable interconnecting member having a first member connected to the first suction cup and a second member connected to the second suction cup,
wherein the first member and the second member slide relative to each other from an extended position to a retracted position.

17. The double suction cup recited in claim 16, wherein when the handle travels within the track from a first position to a second position, the attached collar rotates in a similar rotational direction within the hallow body causing the first member and the second member to slide between:
the extended position, where a first pressure within the first and second suction cups is at a first level; and
the retracted position, where a second pressure within the first and second suction cups is at a second level that is higher than the first level.
